(19) United States
(12) Patent Application Publication
(10) Pub. No.: US 2024/0428563 A1
(43) Pub. Date: Dec. 26, 2024

(54) FEATURE DISTILLATION FOR CLASSIFICATION OF MEDIA CONTENT

(71) Applicants: Lemon Inc., Grand Cayman (KY); Beijing Zitiao Network Technology Co., Ltd., Haidian District (CN)

(72) Inventors: Jinghao Shi, Culver City, CA (US); Xiang Shen, Culver City, CA (US); Kaili Zhao, Culver City, CA (US); Xuedong Wang, Culver City, CA (US); Ya Wen, Culver City, CA (US); Zixuan Wang, Culver City, CA (US); Yifan Wu, Culver City, CA (US); Zhixin Zhang, Beijing (CN)

(21) Appl. No.: 18/820,153

(22) Filed: Aug. 29, 2024

(51) Int. Cl. G06V 10/764; G06V 10/776; G06V 10/80

(52) U.S. Cl. CPC G06V 10/764; G06V 10/776; G06V 10/806

(57) ABSTRACT

Embodiments of the present disclosure provide a solution for classifying a media content. A method comprises: determining a set of target features of a target media content based on first content data of the target media content; and processing, using a first classification model, the set of target features of the media content to generate classification information for the target media content, the first classification model being trained through distilling a second classification model, the second classification model being configured to generate classification information of a first training media content based on both a first set of features and a second set of features of the first training media content, the first set of features being determined based on second content data of the first training media content, and the second set of features being determined based on interaction data associated with the first training media content.

### FIELD

The disclosed example embodiments relate generally to the field of computer science, particularly to a method, device, and storage medium for classifying a media content.

### BACKGROUND

In the domain of media classification, dense features tailored to specific business scenarios are indispensable, yet their complexity and computational demands render them impractical for real-time online inference. The advent of end-to-end multi-modal models has shown significant potential in enhancing efficiency in industrial applications, but the integration of these models often results in the loss of crucial information contained within privileged dense features.

### SUMMARY

In a first aspect of the present disclosure, there is provided a method for classifying a media content. The method comprises: determining a set of target features of a target media content based on first content data of the target media content; and processing, using a first classification model, the set of target features of the media content to generate classification information for the target media content, the first classification model being trained through distilling a second classification model, the second classification model being configured to generate classification information of a first training media content based on both a first set of features and a second set of features of the first training media content, the first set of features being determined based on second content data of the first training media content, and the second set of features being determined based on interaction data associated with the first training media content.

In a second aspect of the present disclosure, there is provided an electronic device. The device comprises at least one processing unit; and at least one memory coupled to the at least one processing unit and storing instructions executable by the at least one processing unit, the instructions, upon execution by the at least one processing unit, causing the electronic device to perform actions comprising: determining a set of target features of a target media content based on first content data of the target media content; and processing, using a first classification model, the set of target features of the media content to generate classification information for the target media content, the first classification model being trained through distilling a second classification model, the second classification model being configured to generate classification information of a first training media content based on both a first set of features and a second set of features of the first training media content, the first set of features being determined based on second content data of the first training media content, and the second set of features being determined based on interaction data associated with the first training media content.

In a third aspect of the present disclosure, a non-transitory computer-readable storage medium is provided. The non-transitory computer-readable storage medium has a computer program stored thereon which, upon execution by an electronic device, causes the device to perform actions comprising: determining a set of target features of a target media content based on first content data of the target media content; and

processing, using a first classification model, the set of target features of the media content to generate classification information for the target media content, the first classification model being trained through distilling a second classification model, the second classification model being configured to generate classification information of a first training media content based on both a first set of features and a second set of features of the first training media content, the first set of features being determined based on second content data of the first training media content, and the second set of features being determined based on interaction data associated with the first training media content.

It would be appreciated that the content described in the Summary section of the present invention is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2 illustrates a flow chart of a process for classifying a media content in accordance with some embodiments of the present disclosure;

FIG. 3 illustrates an example teacher model in accordance with some embodiments of the present disclosure;

FIG. 4 illustrates a block diagram of an apparatus for classifying a media content in accordance with some embodiments of the present disclosure; and

FIG. 5 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. As used herein, the term “model” can represent the matching degree between various data. For example, the above matching degree can be obtained based on various technical solutions currently available and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

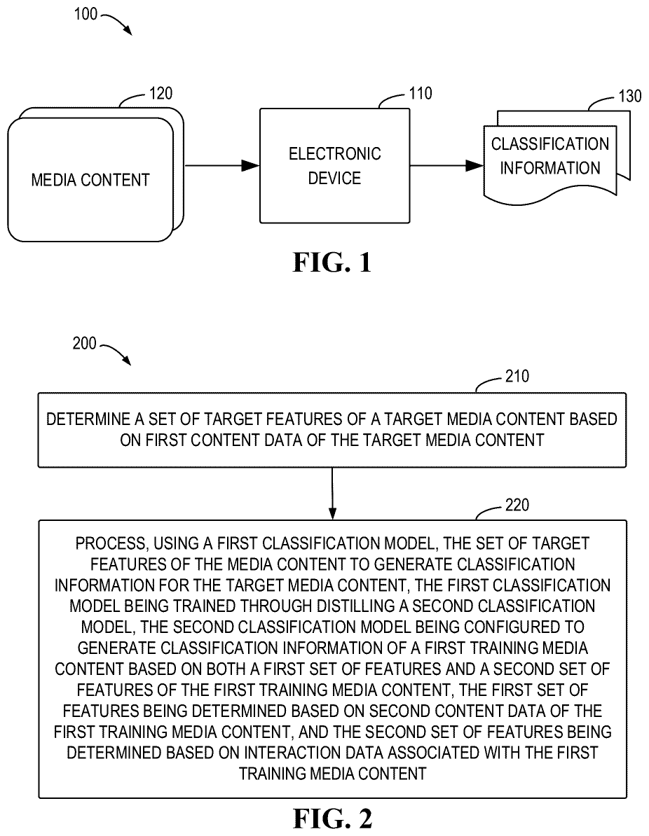

FIG. 1 illustrates a schematic diagram of an example environment 100 in which embodiments of the present disclosure can be implemented. In the example environment 100 of FIG. 1, an electronic device 110 may obtain a set of features of a media content 120 and may provide classification information 130 for the media content 120.

In some embodiments, the classification information 130 may comprise at least one classification label for the media content.

In some embodiments, the electronic device 110 may be any type of mobile terminal, fixed terminal, or portable terminal, including a mobile phone, a desktop computer, a laptop, a notebook, a netbook, a tablet, a media computer, a multimedia tablet, a personal communication system (PCS) device, a personal navigation device, a personal digital assistant (PDA), an audio/video player, a digital camera/video camera, positioning device, television receiver, radio broadcast receiver, e-book device, gaming device, or any combination of the foregoing, including accessories and peripherals for these devices or any combination thereof. In some embodiments, the electronic device 110 can also support any type of user-specific interface (such as “wearable” circuitry). The electronic device 110 can also be various types of computing systems/servers capable of providing computing capability, including but not limited to, a mainframe, an edge computing node, a computing device in cloud environment, and the like.

It should be understood that the structure and function of each element in the environment 100 is described for illustrative purposes only and does not imply any limitations on the scope of the present disclosure.

As discussed, the advent of end-to-end multi-modal models has shown significant potential in enhancing efficiency in industrial applications, but the integration of these models often results in the loss of crucial information contained within privileged dense features.

According to embodiments of the present disclosure, an improved solution for classifying a media content is proposed. According to the solution of embodiments of the present disclosure, a set of target features of a target media content may be determined based on first content data of the target media content. Further, the set of target features of the media content may be processed using a first classification model to generate classification information for the target media content.

The first classification model may be trained through distilling a second classification model, wherein the second classification model is configured to generate classification information of a first training media content based on both a first set of features and a second set of features of the first training media content. The first set of features may be determined based on second content data of the first training media content, and the second set of features may be determined based on interaction data associated with the first training media content.

In this way, by adaptively distilling privileged dense features during training, the embodiments of the present disclosure may enhance the performance of end-to-end multi-modal models without compromising online inference efficiency. Further, the embodiments of the present disclosure may also improve classification accuracy, while maintaining manageable computational costs and operational scalability.

Some example embodiments of the present disclosure will continue to be described below with reference to the accompanying drawings.

FIG. 2 illustrates a flow chart of a process 200 for classifying a media content in accordance with some embodiments of the present disclosure. The process 200 can be implemented at the electronic device 110 as shown in FIG. 1.

As shown in FIG. 2, at block 210, the electronic device 110 determines a set of target features of a target media content based on first content data of the target media content.

In some embodiments, the target media content may comprise any proper type of media, for example, a video content, an image content, an audio content, and the like.

In some embodiments, the electronic device 110 may obtain first content data of the target media content to be classified.

In one example, the first content data may comprise image data associated with the target media content. For example, the image data may comprise a set of frames of a video content.

In another example, the first content data may comprise text data associated with the target media content. For example, the text data may comprise a title and/or a description text of the media content. Additionally, the text data may also comprise text recognized though OCR process on an image of the media content.

Further, the electronic device 110 may encode the set of target features to generate the set of target features.

At block 210, the electronic device 110 processes, using a first classification model, the set of target features of the media content to generate classification information for the target media content, the first classification model being trained through distilling a second classification model, the second classification model being configured to generate classification information of a first training media content based on both a first set of features and a second set of features of the first training media content, the first set of features being determined based on second content data of the first training media content, and the second set of features being determined based on interaction data associated with the first training media content.

For example, the first classification model may process the set of target features of the target media content and generate at least one classification label for the target media content.

The process of training the first classification model will be discussed in detail below.

In some embodiments, a second classification model may be trained first. The second classification model may be also referred to as a teacher model.

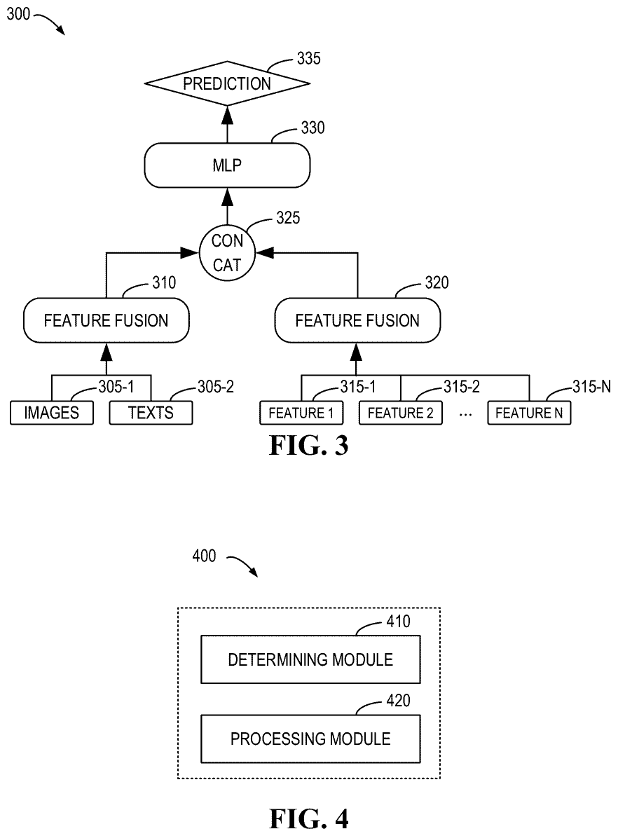

FIG. 3 illustrates an example teacher model 300 in accordance with some embodiments of the present disclosure. As shown in FIG. 3, the teacher model 300 may receive two types of features.

For example, the teacher model 300 may obtain a first set of features through feature fusion unit 310. The first set of features are related to the content data of the first training media content. For example, the image data 305-1 and/or text data associated with the first training media content can be provided to the feature fusion unit 310 to generate the first set of features.

Further, the teacher model 300 may obtain a second set of features through feature fusion unit 320. The second set of features are related to the interaction data of the first training media content.

For example, the interaction data may comprise different types of interaction features, such, feature 315-1, feature 315-2 . . . feature 315-N. Such interaction features may for example comprise any proper interaction statistical data, e.g., view data of a video, video reaction rate, and the like.

The interaction features may also be referred to as dense features, which comprise a rich, high-dimensional representation that is typically extracted from the data through complex computational processes.

As shown in FIG. 3, the first set of features and second set of features may be provided to a concatenation unit 325 to generate a concatenated feature. The concatenated feature can further be provided to a MLP (multilayer perceptron) 330 to generate the prediction results 335.

Further, the first classification model can be obtained through distilling the trained second classification model.

In particular, a first loss based on a first difference between first classification information and reference classification information of a second training media content may be determined, wherein the first classification information is generated by the first classification model.

Further, a second loss based on a second difference may be determined between the first classification information and second classification information for the second training media content, wherein the second classification information is generated by the second classification model.

Additionally, a target loss may be determined based on the first loss and the second loss, and the first classification model may be trained based on the target loss.

For example, the target loss may be determined according to the equations below:

$${ℒ}_{student} = ( 1 - α ) * {ℒ}_{cls} + α * {ℒ}_{distill} \qquad ( 1 )$$

$${ℒ}_{cls} = H ( {q}_{s} , y ) = - {\sum }_{{t}^{`}} {y}_{i} log ( {q}_{s , i} ) \qquad ( 2 )$$

$${ℒ}_{distill} = {D}_{KL} ( {q}_{t} ‖ {q}_{s} ) = {T}^{2} {\sum }_{i} {q}_{t , i} ( T ) log ( \frac{{q}_{t , i} ( T )}{{q}_{s , i} ( T )} ) \qquad ( 3 )$$

wherein, α represents the scaling factor balancing the first loss L_{cls} and the second loss L_{distill}, T is the temperature parameter, qₛ is the predicted probability distribution generated by the student model (i.e., the first classification model), qₜ is the soft target probability distribution generated by the teacher model (i.e., the second classification model), γ is the hard label (i.e., reference classification information).

In some embodiments, the weight information (i.e., the scaling factor α, also referred to as a target weight) can be determined based on a confidence for the second loss classification information. Further, according to Equation (1), a weighted sum of the first loss and the second loss can be calculated according to the weight information to obtain the target loss.

In some embodiments, a target weight (i.e., the scaling factor α) corresponding to the second loss may be proportional to the confidence. As such, the embodiments herein may allow for an adaptive distillation process that enhances the student model's learning efficiency and accuracy. By dynamically adjusting the reliance on the teacher's output based on its confidence, the embodiments may ensure that the student model learns more effectively from the teacher's most reliable predictions, leading to improved overall performance with minimal information loss.

In some embodiments, the loss information for the second training media content of the second classification model can be determined. Further, the confidence can be determined based on the loss information.

In some further embodiments, the confidence may also be determined based on some other proper metrics which may indicate a confidence level of the output of the second classification model, e.g., a probability of a classification label, information entropy of the output of the second classification model.

In some embodiments, the target weight may be determined according to a preset function of the confidence. For example, Table 1 shows four example mapping functions between the confidence and the scaling factor α.

TABLE 1

| Mapping | Description |
|---|---|
| Threshold | α = 0.9 if L_{teacher} < τ else 0.1 |
| Neg Sigmoid | $α = \frac{1}{1 + {e}^{β \cdot ( {L}_{teacher} - {L}_{center} )}}$ |
| Tanh | α = 0.5 · (tanh(−β · (L_{teacher} − L_{center})) + 1) |
| Exp Decay | α = αₘₐₓ · e^{-k·(L}^{_{teacher}}^{-L}^{ₘᵢₙ}⁾ |
| | $where k = - log ( \frac{{α}_{min}}{{α}_{max}} ) / ( {L}_{max} - {L}_{min} )$ |

It should be noted that other proper function may also be applied.

In some embodiments, through the feature distillation, a feature related to interaction data for the target media content is omitted from being input to the first classification model. That is, the brunch related to the feature fusion 320 may be omitted from the student classification model.

In this way, by adaptively distilling privileged dense features during training, the embodiments of the present disclosure may enhance the performance of end-to-end multi-modal models without compromising online inference efficiency. Further, the embodiments of the present disclosure may also improve classification accuracy, while maintaining manageable computational costs and operational scalability.

FIG. 4 shows a block diagram of an apparatus 400 for classifying a media content in accordance with some embodiments of the present disclosure. The apparatus 400 may be implemented, for example, or included at the electronic device 110 of FIG. 1. Various modules/components in the apparatus 400 may be implemented by hardware, software, firmware, or any combination thereof.

As shown, the apparatus 400 comprises a determining module 410, configured for: determining a set of target features of a target media content based on first content data of the target media content; and a processing module 420, configured for: processing, using a first classification model, the set of target features of the media content to generate classification information for the target media content, the first classification model being trained through distilling a second classification model, the second classification model being configured to generate classification information of a first training media content based on both a first set of features and a second set of features of the first training media content, the first set of features being determined based on second content data of the first training media content, and the second set of features being determined based on interaction data associated with the first training media content.

In some embodiments, first content data comprises at least one of: image data associated with the target media content; text data associated with the target media content.

In some embodiments, the first classification model is trained through: determining a first loss based on a first difference between first classification information and reference classification information of a second training media content, the first classification information being generated by the first classification model; determining a second loss based on a second difference between the first classification information and second classification information for the second training media content, the second classification information being generated by the second classification model; determining a target loss based on the first loss and the second loss; and training the first classification model based on the target loss.

In some embodiments, the determining module 410 is further configured for: determining weight information based on a confidence for the second loss classification information; and determining a weighted sum of the first loss and the second loss according to the weight information.

In some embodiments, a target weight corresponding to the second loss is proportional to the confidence.

In some embodiments, the target weight is determined according to a preset function of the confidence.

In some embodiments, the apparatus 400 further comprises a loss determining module, configured for: determining loss information for the second training media content of the second classification model; and determining the confidence based on the loss information.

In some embodiments, a feature related to interaction data for the target media content is omitted from being input to the first classification model.

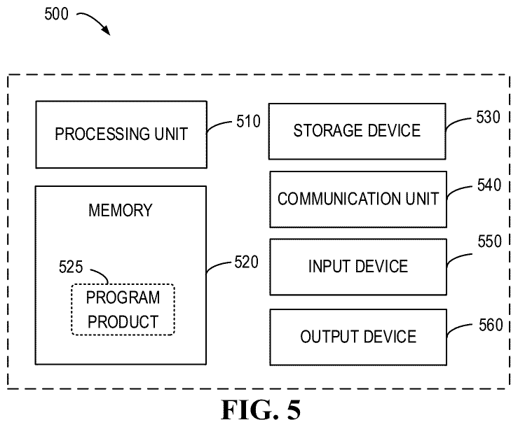

FIG. 5 illustrates a block diagram of an electronic device 500 in which one or more embodiments of the present disclosure can be implemented. It would be appreciated that the electronic device 500 shown in FIG. 5 is only an example and should not constitute any restriction on the function and scope of the embodiments described herein. The electronic device 500 may be used, for example, to implement the electronic device 110 of FIG. 1. The electronic device 500 may also be used to implement the apparatus 400 of FIG. 4.

As shown in FIG. 5, the electronic device 500 is in the form of a general computing device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and can execute various processes according to the programs stored in the memory 520. In a multiprocessor system, multiple processing units execute computer executable instructions in parallel to improve the parallel processing capability of the electronic device 500.

The electronic device 500 typically includes a variety of computer storage medium. Such medium may be any available medium that is accessible to the electronic device 500, including but not limited to volatile and non-volatile medium, removable and non-removable medium. The memory 520 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 530 may be any removable or non-removable medium, and may include a machine-readable medium, such as a flash drive, a disk, or any other medium, which can be used to store information and/or data (such as training data for training) and can be accessed within the electronic device 500.

The electronic device 500 may further include additional removable/non-removable, volatile/non-volatile storage medium. Although not shown in FIG. 5, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 520 may include a computer program product 525, which has one or more program modules configured to perform various methods or acts of various embodiments of the present disclosure.

The communication unit 540 communicates with a further computing device through the communication medium. In addition, functions of components in the electronic device 500 may be implemented by a single computing cluster or multiple computing machines, which can communicate through a communication connection. Therefore, the electronic device 500 may be operated in a networking environment using a logical connection with one or more other servers, a network personal computer (PC), or another network node.

The input device 550 may be one or more input devices, such as a mouse, a keyboard, a trackball, etc. The output device 560 may be one or more output devices, such as a display, a speaker, a printer, etc. The electronic device 500 may also communicate with one or more external devices (not shown) through the communication unit 540 as required. The external device, such as a storage device, a display device, etc., communicate with one or more devices that enable users to interact with the electronic device 500, or communicate with any device (for example, a network card, a modem, etc.) that makes the electronic device 500 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

What is claimed is:

1. A method for classifying a media content, comprising:
determining a set of target features of a target media content based on first content data of the target media content; and
processing, using a first classification model, the set of target features of the media content to generate classification information for the target media content, the first classification model being trained through distilling a second classification model, the second classification model being configured to generate classification information of a first training media content based on both a first set of features and a second set of features of the first training media content, the first set of features being determined based on second content data of the first training media content, and the second set of features being determined based on interaction data associated with the first training media content.

2. The method of claim 1, wherein first content data comprises at least one of:
image data associated with the target media content;
text data associated with the target media content.

3. The method of claim 1, wherein the first classification model is trained through:
determining a first loss based on a first difference between first classification information and reference classification information of a second training media content, the first classification information being generated by the first classification model;
determining a second loss based on a second difference between the first classification information and second classification information for the second training media content, the second classification information being generated by the second classification model;
determining a target loss based on the first loss and the second loss; and
training the first classification model based on the target loss.

4. The method of claim 3, wherein determining a target loss based on the first loss and the second loss comprises:
determining weight information based on a confidence for the second loss classification information; and
determining a weighted sum of the first loss and the second loss according to the weight information.

5. The method of claim 4, wherein a target weight corresponding to the second loss is proportional to the confidence.

6. The method of claim 5, wherein the target weight is determined according to a preset function of the confidence.

7. The method of claim 4, further comprising:
determining loss information for the second training media content of the second classification model; and
determining the confidence based on the loss information.

8. The method of claim 1, wherein a feature related to interaction data for the target media content is omitted from being input to the first classification model.

9. An electronic device, comprising:
at least one processing unit; and
at least one memory coupled to the at least one processing unit and storing instructions executable by the at least one processing unit, the instructions, upon execution by the at least one processing unit, causing the electronic device to perform actions comprising:
determining a set of target features of a target media content based on first content data of the target media content; and
processing, using a first classification model, the set of target features of the media content to generate classification information for the target media content, the first classification model being trained through distilling a second classification model, the second classification model being configured to generate classification information of a first training media content based on both a first set of features and a second set of features of the first training media content, the first set of features being determined based on second content data of the first training media content, and the second set of features being determined based on interaction data associated with the first training media content.

10. The electronic device of claim 9, wherein first content data comprises at least one of:
image data associated with the target media content;
text data associated with the target media content.

11. The electronic device of claim 9, wherein the first classification model is trained through:
determining a first loss based on a first difference between first classification information and reference classification information of a second training media content, the first classification information being generated by the first classification model;
determining a second loss based on a second difference between the first classification information and second classification information for the second training media content, the second classification information being generated by the second classification model;
determining a target loss based on the first loss and the second loss; and
training the first classification model based on the target loss.

12. The electronic device of claim 11, wherein determining a target loss based on the first loss and the second loss comprises:
determining weight information based on a confidence for the second loss classification information; and
determining a weighted sum of the first loss and the second loss according to the weight information.

13. The electronic device of claim 12, wherein a target weight corresponding to the second loss is proportional to the confidence.

14. The electronic device of claim 13, wherein the target weight is determined according to a preset function of the confidence.

15. The electronic device of claim 12, wherein the actions further comprise:
determining loss information for the second training media content of the second classification model; and
determining the confidence based on the loss information.

16. The electronic device of claim 9, wherein a feature related to interaction data for the target media content is omitted from being input to the first classification model.

17. A non-transitory computer-readable storage medium, having a computer program stored thereon which, upon execution by an electronic device, causes the device to perform actions comprising:
determining a set of target features of a target media content based on first content data of the target media content; and
processing, using a first classification model, the set of target features of the media content to generate classification information for the target media content, the first classification model being trained through distilling a second classification model, the second classification model being configured to generate classification information of a first training media content based on both a first set of features and a second set of features of the first training media content, the first set of features being determined based on second content data of the first training media content, and the second set of features being determined based on interaction data associated with the first training media content.

18. The non-transitory computer-readable storage medium of claim 17, wherein first content data comprises at least one of:
image data associated with the target media content;
text data associated with the target media content.

19. The non-transitory computer-readable storage medium of claim 17, wherein the first classification model is trained through:
determining a first loss based on a first difference between first classification information and reference classification information of a second training media content, the first classification information being generated by the first classification model;
determining a second loss based on a second difference between the first classification information and second classification information for the second training media content, the second classification information being generated by the second classification model;
determining a target loss based on the first loss and the second loss; and
training the first classification model based on the target loss.

20. The non-transitory computer-readable storage medium of claim 19, wherein determining a target loss based on the first loss and the second loss comprises:
determining weight information based on a confidence for the second loss classification information; and
determining a weighted sum of the first loss and the second loss according to the weight information.
